(19) United States
(12) Patent Application Publication
(10) Pub. No.: US 2013/0252601 A1
(43) Pub. Date: Sep. 26, 2013

(54) REMOTE CONTROL METHOD FOR SNOW REMOVAL AND DISASTER PREVENTION SYSTEM USING SMART PHONE

(71) Applicants: Seung-Gu Yu, Icheon-si (KR); Seung-Hoon Lee, Goyang-si (KR)

(72) Inventors: Seung-Gu Yu, Icheon-si (KR); Seung-Hoon Lee, Goyang-si (KR)

(73) Assignee: JOYFUL FUTURE CO., LTD., Icheon-si, Gyeonggi-do (KR)

(21) Appl. No.: 13/989,758

(22) PCT Filed: Nov. 29, 2011
(86) PCT No.: PCT/KR2011/009162

§ 371 Date: May 24, 2013

(30) Foreign Application Priority Data
Nov. 29, 2010 (KR) 10-2010-0119851

(51) Int. Cl. H04W 4/00

(52) U.S. Cl. CPC H04W 4/001
USPC 455/420

(57) ABSTRACT

Provided is a remote control method of a snow removal system using a smart phone, which remotely controls the system installed at a site while checking conditions of a road and the system in real time when improvement of a road surface is needed because a condition of the road surface deteriorates due to dusts, yellow sand, frozen snow on the road surface, etc. The remote control method includes: accessing a remote terminal device in real time; allowing the access of the authorized manager using the smart phone; transmitting data; driving a CPU of the remote terminal device with SMS data to output a data value; stopping operation of the pump; comparing data input or output values stored and set in the CPU and a memory; determining whether to continuously perform a current operation; obtaining collected information; and feeding back all of the processed results to the smart phone.

### BACKGROUND OF THE INVENTION

1. Technical Field

The present invention relates to a remote control method for snow removal and disaster prevention system using smart phone, and more particularly, to a remote control method for snow removal and disaster prevention system using a smart phone, which remotely controls the snow removal system installed at a site while checking conditions of a road and the snow removal system in real time when improvement of a road surface is needed because a condition of the mad surface deteriorates due to dusts, yellow sand, frozen snow on the road surface, etc. that occur in cities.

2. Description of the Related Art

Generally, when snow is piled up or frozen on a road surface in a vulnerable place such as a straight road, a bridge, a curved road, an uphill road, an entrance of a tunnel, or the like, the piled-up or frozen snow obstructs a traffic flow, and a road condition deteriorates. Dusts piled up on a road are the same.

As an example of a method of removing and thawing snow, there is a method that sprays a thawing agent and a snow removing agent such as calcium chloride, or a friction agent such as sand, a grain particle chip, or the like. The method has limitations in that it is almost impossible to uniformly spray a spraying agent on a surface of a multilane road having a broad width, and traffic control and congestion are accompanied. Also, them is a method that mechanically sprays a spraying agent using a spray vehicle, but the method has limitations in traffic control and the use of equipment.

In snow-removing and thawing work dependent on the use of equipment and manpower, since equipment and manpower should be put to a site, it is substantially impossible to quickly remove snow. For this reason, various methods are studied.

“Spraying device of removal of snow on the mad” disclosed in Korean Patent Registration No. 225035 and “a cats eye mad marker with spray” disclosed in Korean Patent Registration No. 750937 are representatively known for removing snow.

These are technologies proposed for previously restoring and quickly measuring a road surface requiring removal of snow, and are technologies proposed for replacing the jet of a spraying agent with mechanical spray.

“Spraying device of removal of snow on the road” disclosed in Korean Patent Registration NO. 225035, as illustrated in FIG. 1, includes an installation chamber 10, a snow removing agent storage tank 11, a compressor 12, and a plurality of jet ports 13 connected to the compressor 12. In the spraying device, a jet port 13 is installed to have a certain height from a central lane and central reservation of a road 14 or an edge of a road surface, and a snow removing agent is sprayed on the road surface. In such technology, since a spray means is separated from a jet means, integrated management is difficult. As the spraying device is simply a road facility for spraying a spraying agent on a road surface, usability is low. Since the spraying device operates according to direct manipulation, the spraying device is difficult to early respond. The spraying device has a restriction in selecting an installation position, and is impossible to movably install.

“A cat's eye road marker with spray” disclosed in Korean Patent Registration No. 750937, as illustrated in FIG. 2, includes a body 20 with a reflective plate 21 attached thereto, a supporting pillar 22 that is installed as a whole under the body 20 and supports the body 20, and a coupling bolt coupled to the supporting pillar 22 through the body 20. A spray nozzle 23, connected to a liquid supply source 26 through a connector 24, is built in an internal space of the body 20 so as to jet liquid. The body 20 is buried under the ground and fixed by a bracket 27, and jets contents of the liquid supply source 26 to the spray nozzle 23 through a pump 25.

In the technology, since the road marker is installed at a central reservation portion, the mad marker is immovable, and there is a high possibility that the nozzle is blocked or damaged. Also, it is impossible to remotely control the time of jetting, and thus, the technology is difficult to early respond. Since a liquid supply means is separated from a jet means, integrated management is difficult, and there are many restrictions in selecting an installation position.

“Remote controlled scattering apparatus”, disclosed in Korean Patent Registration No. 0985174 filed by the applicant, enables an early response to remove the snow through real-time remote control.

The related art apparatuses for spraying liquid on a road, which include a remote control function using wired/wireless data communication, are all installed to be neglected on roads, and thus, due to carelessness and negligence in surveillance, it is unable to respond to damage or robbery of expensive application components.

Moreover, since the liquid spraying apparatus is neglected and put in an operation standby state, more accurate control is needed depending on ambient conditions. For example, it is required to transfer various pieces of information, which is necessary for operating the liquid spraying apparatus, such as road condition information and a current facility management state, to a manager in real time. For example, the information includes climatic and environmental information, affecting an operation of the liquid spraying apparatus, such as a temperature, a humidity, etc.

In addition, by acquiring and transferring various pieces of information necessary for a remote control operation, an efficient operation can be expected, but, current technology is still in fundamental power control such as simple power control and pump driving by wired/wireless data communication.

### SUMMARY OF THE INVENTION

Accordingly, An aspect of the present invention is directed to provide a remote control method for snow removal and disaster prevention system using smart phone, in which the snow removal system is installed near a road, and remotely controlled to jet a spraying agent necessary for improving a road surface without the put of manpower and equipment and traffic congestion.

Another aspect of the present invention is directed to provide a remote control method for snow removal system which checks and reads a condition of the snow removal system installed on a road in real time, and continuously manages the snow removal system.

Another aspect of the present invention is directed to provide a remote control method fir snow removal system which transfers various pieces of information necessary for operating the snow removal system to a manager in real time, and enables the manager to remotely control the snow removal system.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided a method of remotely controlling a snow removal system using an external case 107, in which a body 103 storing the spraying agent 102, the pump 105, and the nozzle 106 are installed, a remote terminal device 200 that is installed in the external case 107 and recognizes SMS data to be driven, and a smart phone 500 that includes an application 501 for transmitting and receiving a data value in connection with the remote terminal device 200, the method including: accessing a mobile communication network 400 with the smart phone 500 to access the remote terminal device 200 through a data communication unit 201 in the snow removal system installed at a site in real time; determining whether a user accessed through the accessing is an authorized manager, and, when it is determined that the accessed user is not the authorized manger, blocking the access to the smart phone to allow the access of the authorized manager using the smart phone; transmitting data by using the smart phone 500; driving a central processing unit (CPU) of the remote terminal device 200 with SMS data, transmitted through the transmitting, to output a data value; driving the pump 105 installed at the site to spray the spraying agent 102 through a nozzle 106, or slopping operation of the pump 105 to stop the spray of the spraying agent 102; determining whether to spray the spraying agent 102 according to whether the pump 105 is driven, and comparing data input or output values stored and set in the CPU and a memory of the remote terminal device 200 to transmit detection information to the manager; checking a data value, transmitted through the transmitting, with contents displayed by the smart phone 500 to determine whether an error occurs, and determining whether to continuously perform a current operation according to the determined result; obtaining collected information to check an overall state of the remote snow removal system to input and transfer necessary contents as SMS data by using the smart phone 500; and feeding back all of the processed results to the smart phone 500.

The processing of the SMS data processed by the remote terminal device 200 may include: transmitting the SMS data from the smart phone 500 to receive the SMS data; extracting a teleservice ID from the SMS data; checking an application corresponding to the teleservice ID; determining whether the application matches the teleservice ID, and, when there is a mismatch therebetween, stopping a service, or, when there is a match therebetween, allowing generation of application data; generating new application data; mapping the generated application to an application program of the control unit 206 of the remote terminal device 200; and driving, when SMS data based on the application is received, the remote terminal device 200 with the SMS data to control driving of the pump 105 to control the spray of the spraying agent 102.

In the remote terminal device 200, the control unit 209 may selectively control one or more selected from among a display element unit 202, a surveillance camera 204, a detection sensor 205, and a flow rate measurement sensor 210, and transmit external environmental information with an application of the smart phone 500 in real time.

A control command executed by the controller 209 may be executed through the CPU that receives the SMS data of the smart phone and has an integrated control function for a microprocessor or a microcomputer included in the control unit 206 of the remote terminal device 200, a programmable logic controller (PLC) that controls the pump 105 according to a programmed command input as data of the smart phone 500 side, and a remote terminal unit (RTU) that collects data output from the pump 105 and performs comparison control.

The remote terminal device 200 may transmit signals, transmitted between a programmable logic controller (PLC) and a remote terminal unit (RTU) of the control unit 206, to the smart phone 500 through a human machine interface (HMI) to display an image or text corresponding to the signals.

The external environmental information may transmit control and measurement information which includes one or more of a contact impact on a structure of the snow removal system installed on a road, sound, light an acceleration, a distance, a humidity, a temperature, and a flow rate of the spraying agent.

The method may further include outputting a flow rate detected by the flow rate measurement sensor 210 to the control unit 206, and comparing and calculating the output value to check whether the spraying agent 102 is lost and robbed and an operation is normally performed based on a change amount of the flow rate by using the smart phone 500.

The smart phone 500 may include: an application 501 transmitting SMS data to the control unit 206 through the data communication unit 201 of the remote terminal device 200; a program operating system (OS) 502 including the application 501, and driving the remote terminal device 200; and a telephoney application interface (TAPI) 503 receiving data transmitted from the remote terminal device 200 by using an inter-process connection (IPC), extracting a teleservice identifier (ID) from the data, checking the application 501 corresponding to the data with the teleservice ID, generating data of the application 501 in a type enabling a service by the checked application 501 with user data included in the SMS data and the teleservice ID, and mapping the generated data to the checked application 501, and the smart phone 500 may be controlled by the smart phone.

It is to be understood that both the foregoing general description and the following detailed description of the present invention are exempla) and explanatory and are intended to provide further explanation of the invention as claimed.

### BRIEF DESCRIPTION OF THE DRAWINGS

The above and other objects, features and advantages of the present invention will be more clearly understood from the following detailed description taken in conjunction with the accompanying drawings, in which;

FIG. 1 is a view for describing a related art apparatus for spraying a snow removing agent on a road;

FIG. 2 is an installation sectional view illustrating a related art road marker with a spray function;

FIG. 3 is an entire appearance view illustrating a snow removal system according to an embodiment of the present invention;

FIG. 4 is a sectional view illustrating the snow removal system according to an embodiment of the present invention;

FIGS. 5 and 6 are photographs illustrating an actual product and installation state of the snow removal system according to an embodiment of the present invention;

FIG. 7 is a view for describing remote control of the snow removal system according to an embodiment of the present invention;

FIG. 8 is a block diagram illustrating a remote terminal device of the snow removal system according to an embodiment of the present invention;

FIG. 9 is a block diagram illustrating the snow removal system according to an embodiment of the present invention and use of power;

FIG. 10 is a block diagram illustrating remote control of the snow removal system according to an embodiment of the present invention;

FIG. 11 is a flowchart illustrating remote; control of the snow removal system according to an embodiment of the present invention; and

FIG. 12 is a flowchart illustrating a data processing method performed in the remote terminal device according to an embodiment of the present invention.

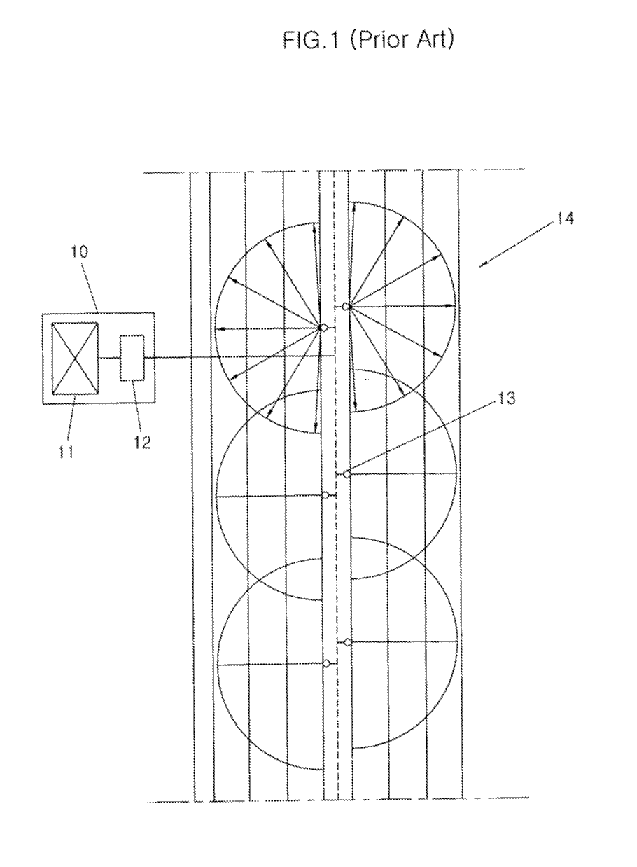

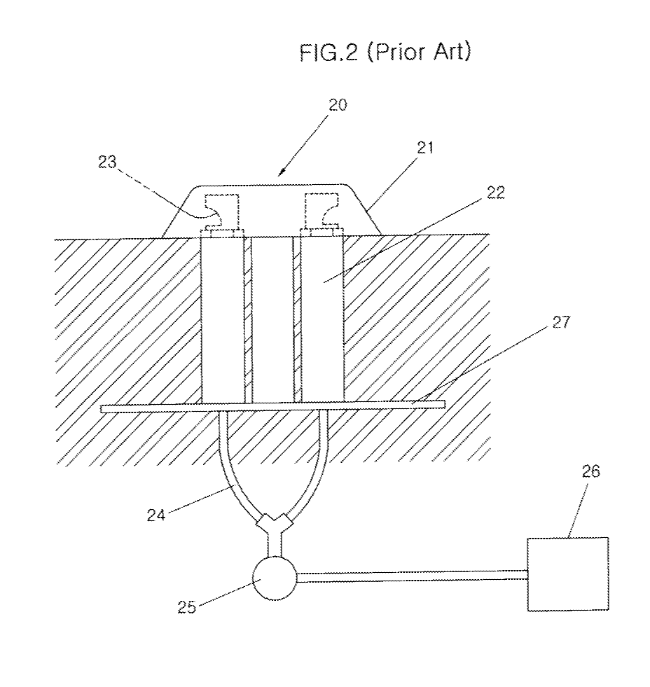

### DESCRIPTION OF THE PREFERRED EMBODIMENTS

Hereinafter, embodiments of the present invention will be described in more detail with reference to the accompanying drawings.

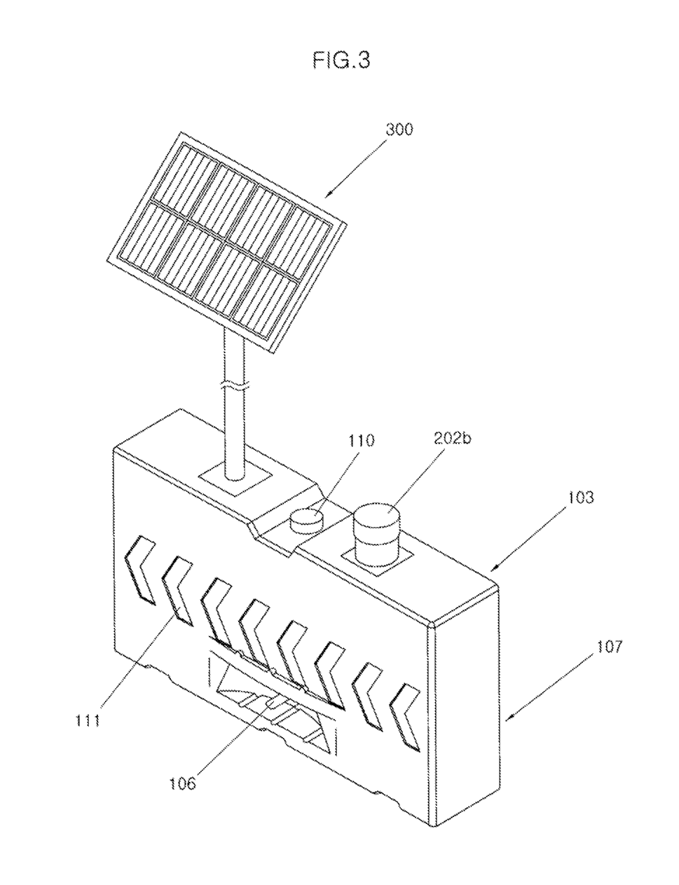

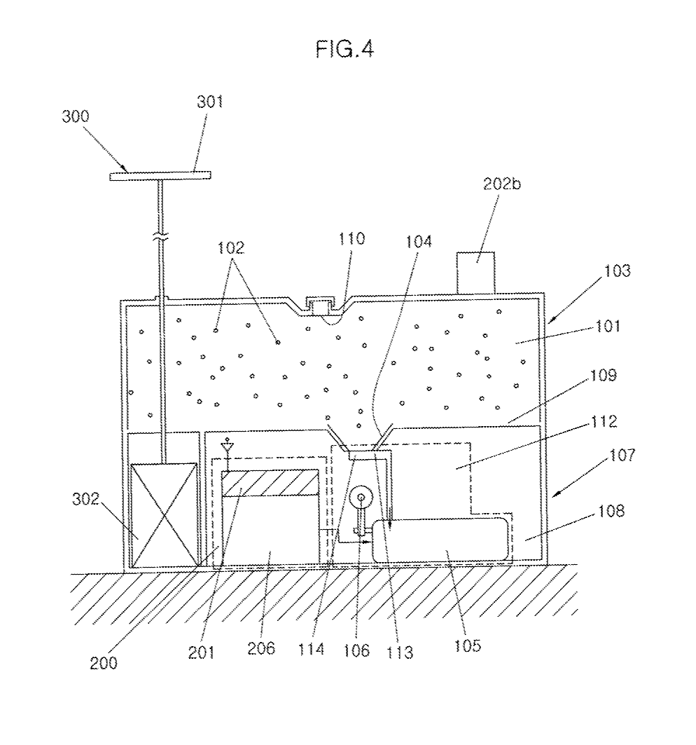

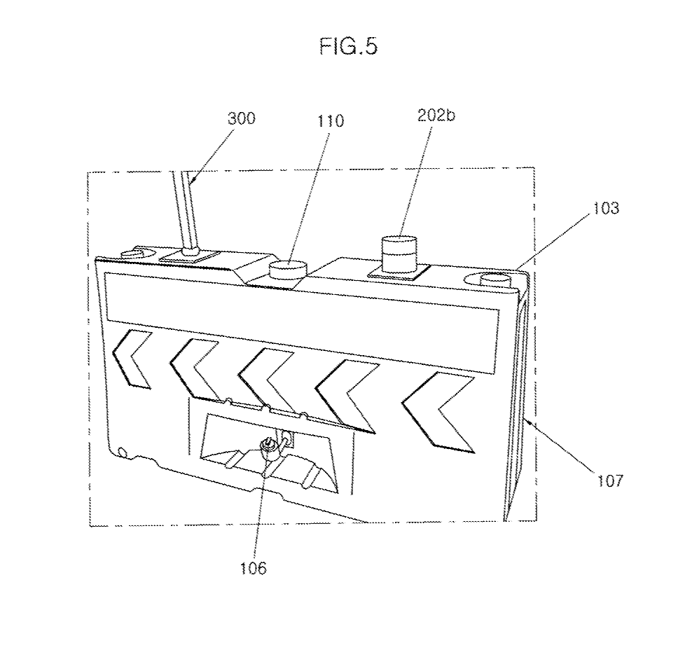

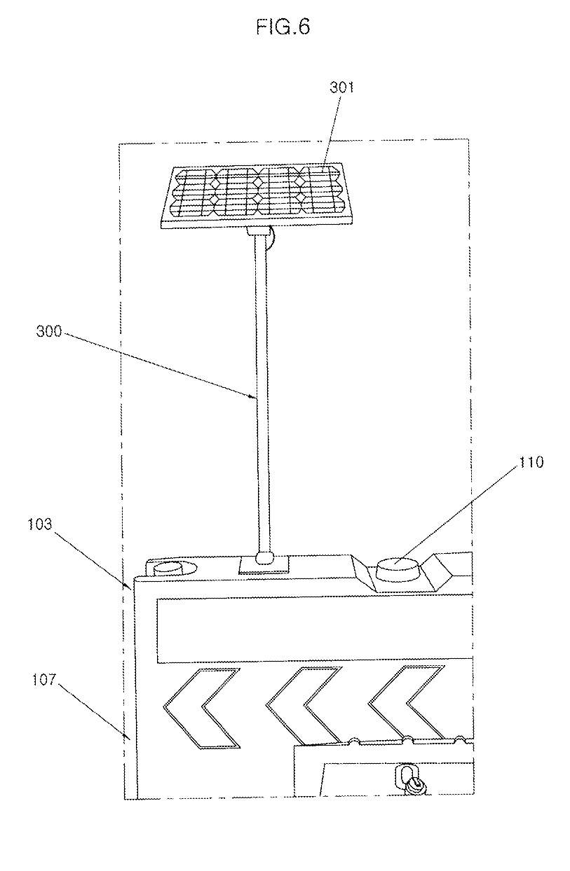

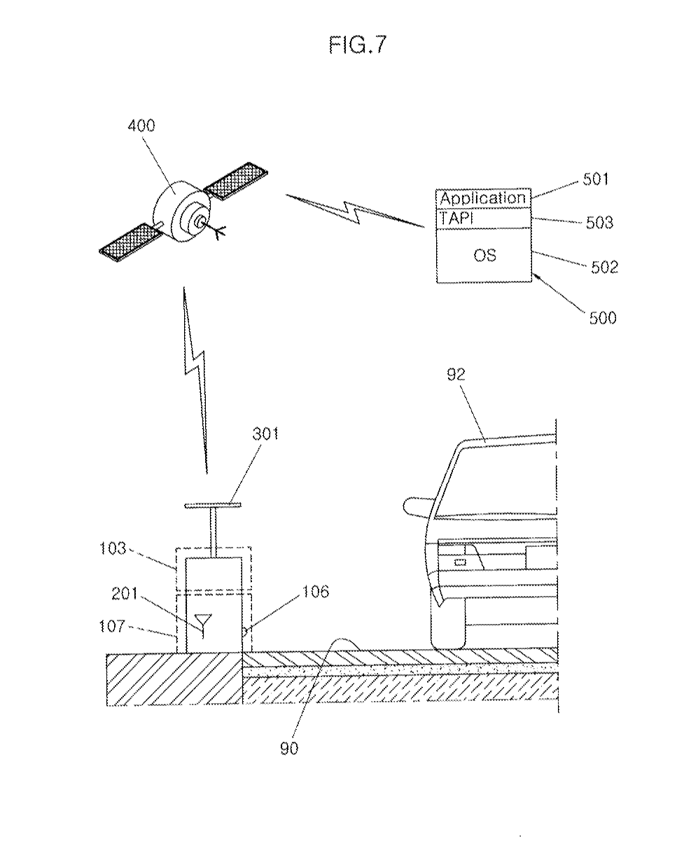

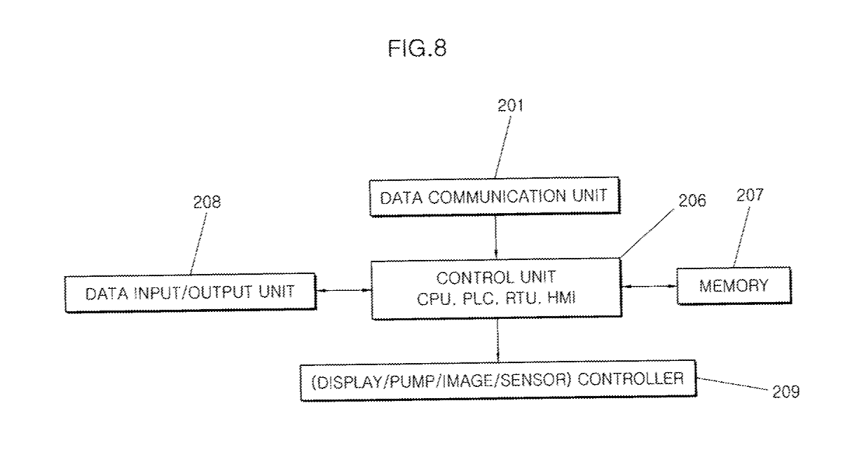

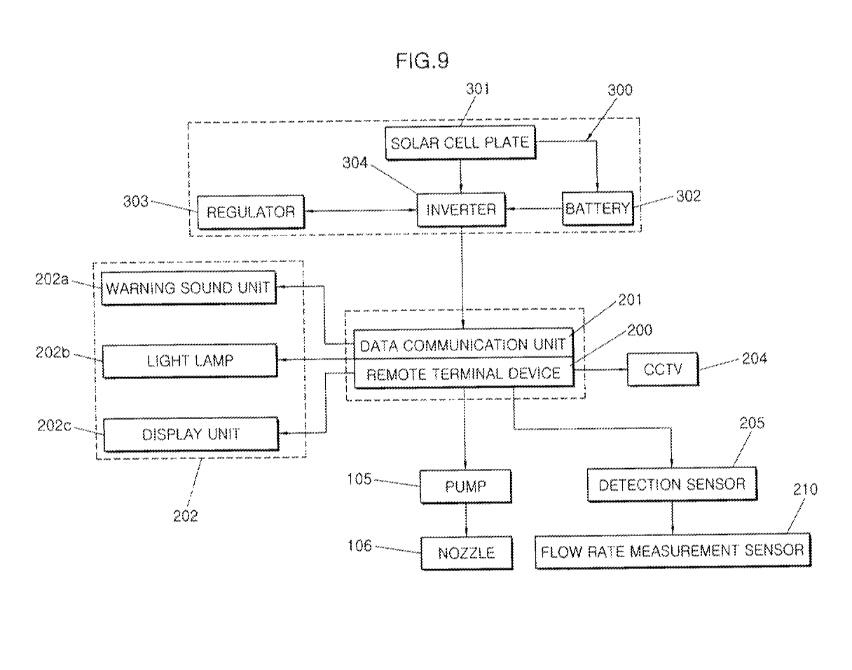

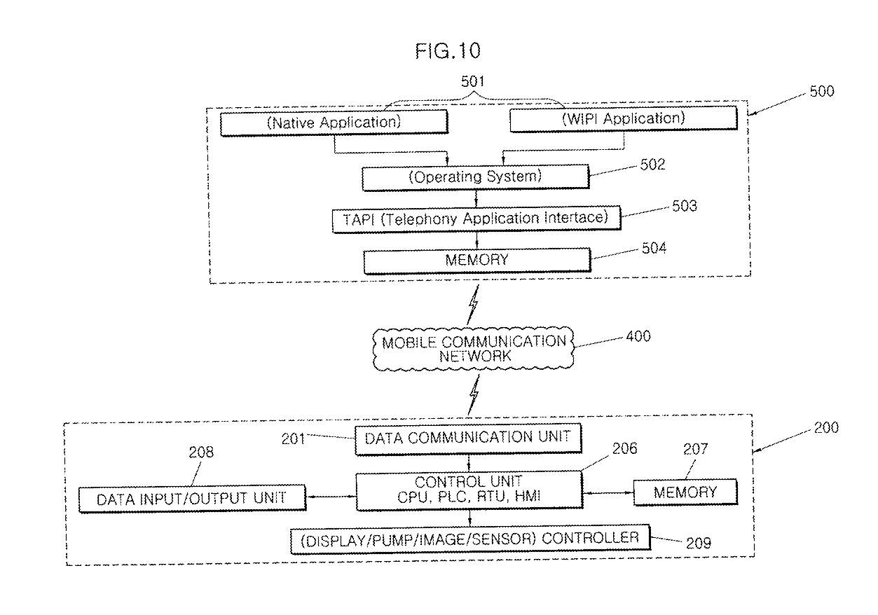

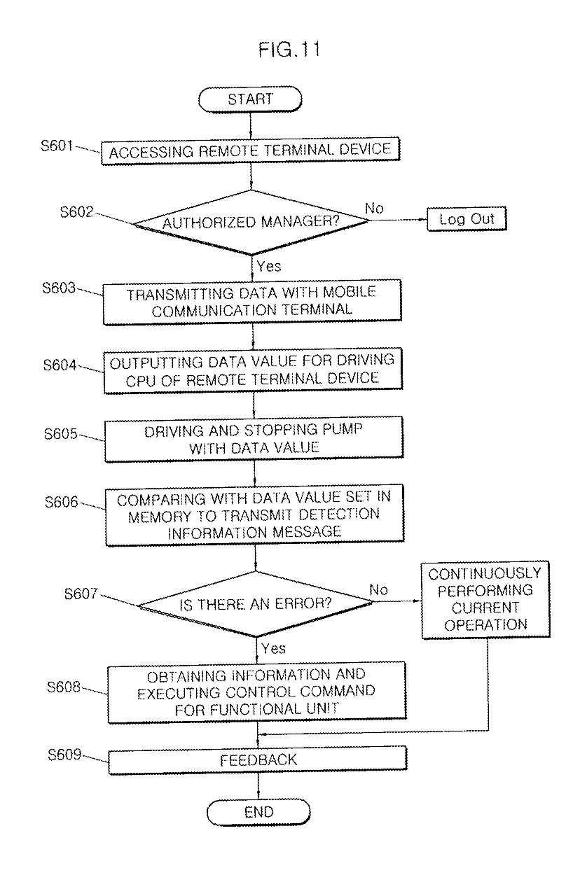

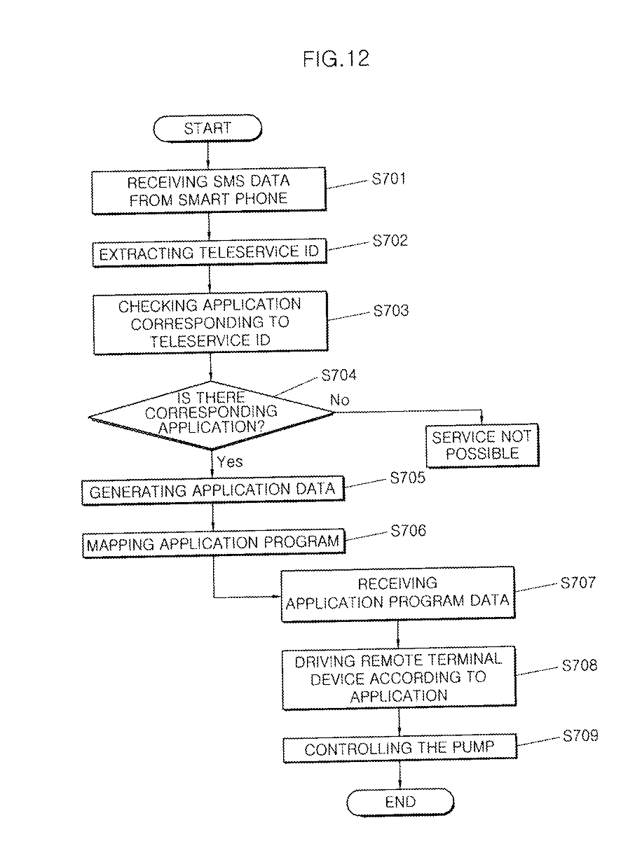

FIG. 3 is an entire appearance view illustrating a snow removal system according to an embodiment of the present invention. FIG. 4 is a sectional view illustrating the snow removal system according to an embodiment of the present invention. FIGS. 5 and 6 are photographs illustrating an actual product and installation state of the snow removal system according to an embodiment of the present invention. FIG. 7 is a view for describing remote control of the snow removal system according to an embodiment of the present invention. FIG. 8 is a block diagram illustrating a remote terminal device of the snow removal system according to an embodiment of the present invention. FIG. 9 is a block diagram illustrating the snow removal system according to an embodiment of the present invention and use of power. FIG. 10 is a block diagram illustrating remote control of the snow removal system according to an embodiment of the present invention. FIG. 11 is a flowchart illustrating remote control of the snow removal system according to an embodiment of the present invention. FIG. 12 is a flowchart illustrating a data processing method performed in the remote terminal device according to an embodiment of the present invention.

A representative example of the snow removal system to be remotely controlled according to an embodiment of the present invention is as illustrated in FIGS. 3 to 6.

The snow removal system of FIGS. 3 to 6 fundamentally includes a remote terminal device 200 that is connected to a mobile communication network 400 and transmits/receives data.

A structure part of the snow removal system includes a cylinder-shaped body 103 which is installed near a road and includes a storage room 101 configured as a space storing a spraying agent 102. The body 102 configures an upper structure.

The snow removal system includes an external case 107 in which an inlet 104 connected to the storage room 101 of the body 103 is provided, a pump 105 that receives the spraying agent 102 through the inlet 104 and transfers the received spraying agent 102 is installed, and a nozzle 106 that jets the spraying agent 102 transferred from the pump 105 is installed. The external case 107 configures a lower structure.

An example applying a solar cell part 200 for replacing commercial electricity is illustrated in FIGS. 3 to 6. A solar cell plate 301 is installed outside the body 103 and the external case 107, for supplying power necessary for a plurality of driving components including the pump 105 and the remote terminal device 200.

The body 103 and the external case 107 may be configured as one body, or separately configured. FIGS. 3 and 4 illustrate an example of an integrated structure.

The remote terminal device 200 is built in the external case 107. The remote terminal device 200 includes a data communication unit 201, and processes external SMS data received through the data communication unit 201 to recognize application SMS data of a smart phone 500 applied for controlling driving of the pump 105 and functional parts, thereby driving the pump 105 and the functional parts.

The remote terminal device 200 includes a bidirectional data communication unit 201 that receives external application SMS data over the mobile communication network 400 and transmits predetermined information over the mobile communication network 400, and a control unit 206 that is connected to a display element unit 202, the pump 105, a surveillance camera 204, a detection sensor 205, and a flow rate measurement sensor 210 to input/output signal data and calculates and inputs/outputs a data signal in connection with a controller 209 installed in one or more of the elements.

The remote terminal device 200 includes a memory 207 that is connected to the control unit 206 and the data communication unit 201, and stores data transmitted and calculated between a remote terminal unit and a programmable logic controller of the control unit 206 and a calculation result by a processor. Also, the remote terminal device 200 includes a data input/output unit 208 that inputs/outputs system default data or variable data to/from a plurality of units.

Here, the control unit 206 includes a central processing unit (CPU) that has an integrated control function for a microprocessor, a main control unit (MCU), and a microcomputer, a programmable logic controller (PLC) that controls the pump 105 according to a programmed command input as SMS data of the smart phone 200 side, and an remote terminal unit (RTU) that collects data output from the pump 105 and performs comparison control.

The control unit 206 further includes a human machine interface (HMI) that transmits signals, transmitted between the PLC and the RTU, to the smart phone 500 through the data communication unit 201 to visually display an image or text corresponding to the signals, and inputs/outputs data.

The control unit 206 includes the detection sensor 205 that senses external environmental information, and the flow rate measurement sensor 210 that checks a flow rate of the spraying agent 102 stored in the storage room 101 of the body 103. The control unit 206 outputs information, detected by the detection sensor 205 and the flow rate measurement sensor 210, to the data communication unit 201 to enable the data to be transmitted to the smart phone 500. A processor built in the smart phone 500 programs data of detection information supplied from the control unit 206, thereby displaying the external environmental information and measurement information, detected by the detection sensor 205 and the flow rate measurement sensor 210, through the smart phone 500.

Here, the external environmental information includes one or more of a contact impact on the body 103 and the external case 107 that are installed on a road, sound, light, an acceleration, a distance, a humidity, and a temperature.

The data communication unit 201 receives an SMS data signal sent by a manager from the smart phone 500 so as to control the remote snow removal system, and inputs the SMS data signal to the remote terminal device 200 or transmits information, calculated by the remote terminal device 200, to the manager.

In a remote control method of the snow removal system according to the present invention, as illustrated in the flowchart of FIG. 11, the smart phone 500 controls the snow removal system connectable to the mobile communication network 400 in real time.

Here, the smart phone 500 includes an application 501 that transmits SMS data to the control unit 206 through the data communication unit 201 of the remote terminal device, 200, a program operating system (OS) 502 that includes the application 501 and drives the remote terminal device 200, and a telephoney application interface (TAPI) 503 that receives data transmitted from the remote terminal device 200 by using an inter-process connection (IPC) extracts a teleservice identifier (ID) from the data, checks the application 501 corresponding to the data with the teleservice ID, generates data of the application 501 in a type enabling a service by the checked application 501 with user data included in the SMS data and the teleservice ID, and maps the generated data to the checked application 501. The smart phone 500 stores transmitted/received information in the memory 504, and extracts desired information from the memory 504.

In the control method of the snow removal system using the smart phone 500, a user of the smart phone 500 accesses the mobile communication network 400, and accesses the remote terminal device 200 of the snow removal system installed at a site in real time, in operation S601.

The control unit 206 determines whether the user accessed through operation S601 is an authorized manager. When it is determined that the accessed user is not the authorized manger, the control unit 206 blocks the access to the smart phone 500, and allows the access of the authorized manager using the smart phone 500, in operation S602.

The manager allowed through operation S602 transmits data using the smart phone 500, in operation S603.

The CPU of the remote terminal device 200 is driven by the data value transmitted through operation S603 to output a data value, in operation S604.

In operation S605, by driving the pump 105 installed at the site, the spraying agent 102 is sprayed through the nozzle 106, or, by stopping operation of the pump 105 that is spraying the spraying agent 102, the spray of the spraying agent 102 is stopped.

Whether to spray the spraying agent 102 is determined according to whether the pump 105 is driven, in operation S605. The control method compares data input/output values stored and set in the CPU and memory of the remote terminal device 200 to transmit detection information to the manager, in operation S606.

The manager checks a data value transmitted through operation S606 by using contents displayed by the smart phone 500 to determine whether an error occurs, and determines whether to continuously perform a current operation according to the determined result in operation S607.

The manager obtains information collected through operation S607 to check an overall state of the remote snow removal system by using the smart phone 500, and selectively transfers a control command to each of the functional units through the controller 209, in operation S608.

The processed result by operation S608 is fed back to the manager through the smart phone 500, and is stored, in operation S609.

Moreover, an example of an SMS data processing operation performed by the remote terminal device 200 is as illustrated in the flowchart of FIG. 12.

SMS data is transmitted from the smart phone 500, and, when the SMS data is received in operation S701, the remote terminal device 200 extracts a teleservice ID of the SMS data in operation S702, and checks an application corresponding to the teleservice ID in operation S703. When the corresponding application does not match the teleservice ID, the remote terminal device 200 stops a service. When the corresponding application matches the teleservice ID, the remote terminal device 200 allows generation of new application data in operation S704, and the smart phone 500 generates the new application data in operation S705. The remote terminal device 200 maps the generated application data to an application program of the control unit 206 in operation S706. In operations S707 to S709, SMS data based on an application is input to the remote terminal device 200, and the remote terminal device 200 is driven with the SMS data to control operation of the pump 105, thereby controlling the spray of the spraying agent 102.

Moreover, a control command for each functional unit executed in operation S608 is tier one or more selected from among the display element unit 202, the surveillance camera 204, the detection sensor 205, the flow rate measurement sensor 210, and the controller 209 selectively executes the control command for each functional unit.

Here, the display element unit 202 includes a means (generating warning sound 202a) such as a buzzer (speaker), a light lamp 202b installed in the system body 103 and the external case 107 to be exposed, a light emitting unit 202c that visually shows a driving state like a light emitting diode (LED), etc. The display element unit 202 is selectively installed and operated depending on a site condition.

The surveillance camera 204 captures a site of the snow removal system installed at the site to store the captured site image, or transmits image data through the remote terminal device 200 so as to monitor the site in real time. The surveillance camera 204 is selectively installed and operated depending on a site condition.

The control command executed by the controller 209 is executed through the CPU that receives the SMS data of the smart phone 500 and has an integrated control function for the microprocessor or microcomputer included in the control unit 206 of the remote terminal device 200, the PLC that controls the pump 105 according to a programmed command input as SMS data of the smart phone 500 side, and the RTU that collects data output from the pump 105 and performs comparison control.

The flow rate measurement sensor 210 is installed in the storage room 101 of the body 103, and detects a flow rate to output the detected flow rate to the control unit 206. The control unit 206 compares and calculates the output value of the flow rate measurement sensor 210 to check whether the spraying agent 102 is lost and robbed and an operation is normally performed based on a change amount of the flow rate by using the smart phone 500.

The display element unit 202 may include a warning sound unit 202a using a buzzer, the light lamp 202b, and the display unit 202c.

When an impact or a contact similar thereto is applied on the body 103 or the external case 107, or a level of the spraying agent 102 is rapidly reduced abnormally, the detection sensor 205 or the flow rate measurement sensor 210 detects the impact or the reduced spraying agent, and the warning sound unit 202a outputs warning sound through a speaker or buzzer (not shown).

The light lamp 202h emits light while the spraying agent 102 is sprayed. Alternatively, when an impact or a contact similar thereto is applied on the body 103 or the external case 107, or a rapid reduction in a level of the spraying agent 102 stored in the storage room 101 is detected by the detection sensor 205 and the flow rate measurement sensor 210, the light lamp 202b emits light for externally warning the impact/contact or the rapid reduction. Here, a time when the light lamp 202b emits light may be freely set according to a program set in the control unit 206 of the remote terminal device 200.

The display unit 202c, although not specifically shown in the drawing, may use an LED. The LED is more suitable for displaying various driving states than a general lamp. A driving signal of the display unit 202c may be variously controlled by the display/pump/image/sensor controller 209 of the control unit 206.

The remote terminal device 200 receives an SMS data signal, transmitted from the smart phone 500 through the mobile communication network 400, through the data communication unit 201 in real time. The control unit 206 of the remote terminal device 200 outputs the SMS data signal as a data signal value, and thus the CPU controls the pump 105, the display element unit 202, the surveillance camera 204, the detection sensor 205, the flow rate measurement sensor 210, thereby storing and controlling data.

It is suitable to use a wireless communication network, for example, a communication network provided by a commercial mobile communication provider, instead of a wired communication network, as the mobile communication network 400

In a processing type of a data signal, remote control is executed by transmitting short sentence text SMS data. The short sentence text SMS data using a smart phone has no limitation in a buffer, an error, and an amount of input/output information compared to different data, and thus is suitable as high-reliability data.

Power necessary for driving the snow removal system, for example, may use alternating current (AC). A power source may use a commercial power source or a solar energy system that converts solar energy, including electromagnetic radiation with a wavelength within a sola band, into electrical energy.

The remote control of the snow removal system using the smart phone according to the present invention is performed with the smart phone 500. In addition, a wireless communication service using a wireless communication network based on computer, electronic, and communication technology may be used.

A service provided in a mobile communication system includes a voice service, and a multimedia communication service transmitting data such as circuit data or packet data.

The smart phone includes a large-capacity memory and a high-performance CPU compared to the existing mobile communication terminals, and moreover includes an OS for supporting execution of various applications, voice/data communication, and a personal computer (PC) connection. For example, the OS may representatively use Symbian, WindowsCE, or Linux.

Korea adopted wireless Internet platform for interoperability (WIPI) as wireless Internet platform standard for portable phones, and mobile communication providers and terminal manufacturers install (port) the WIPI between an OS (for example REX or the like) layer and application layer of a mobile communication terminal.

As described above, the existing mobile communication terminals are released with the WIPI being installed in the existing OS such as REX. However, since the WIPI is not installed in smart phones that are recently released, mobile communication providers and terminal manufacturers are developing technology that installs the WIPI in smart phones such that applications (for example, browser, wireless Internet menu, contents, bell sound, video, word processing program, etc.) executed based on the WIPI are smoothly executed in the smart phones.

FIG. 10 is a block diagram illustrating a data link between the remote terminal device 200 and the system elements of the smart phone 500 that is a type of mobile communication terminal.

The smart phone 500 includes a native application 501, a WIPI application 501, the OS 502, the TAPI 503, and the memory 504.

The native application 501 corresponds to various applications (website browsing, contents download, and multimedia message (S)MMS writing, etc.) that are driven by the native platform in the smart phone 500.

The WIPI application 502 corresponds to various applications (website browsing, contents download, and multimedia message MMS writing, etc.) that are driven by the native platform in the smart phone 500.

The OS 502 is a control means that controls an overall operation of the smart phone 500.

The TAPI 503 receives data transmitted from the remote terminal device 200 by using an inter-process connection (IPC), extracts a teleservice identifier (ID) from the data checks the application 501 corresponding to the data with the teleservice ID, generates data of the application 501 in a type enabling a service by the checked application 501 with user data included in the SMS data and the teleservice ID, and maps the generated data to the checked application 501.

The memory 504 is a storage means that stores various data necessary for driving the smart phone 500.

In the smart phone 500, various applications, for example, various kinds of the WIPI applications 501 executed based on the WIPI and the native application 501 executed based on a structure of a window mobile platform, are installed on the OS (i.e., Symbian, WindowsCE, or Linux) 502. Each of the applications is read from, written in, or deleted from a specific area of the memory 504 to which various data necessary for executing the smart phone 500 are allocated from the OS 502.

The OS 502 of the smart, phone 500 treats the WIPI as an application, and thus teats the WIPI applications 501 executed based on the WIPI or the native application 501 executed based on a structure of a window mobile platform as one application, whereby a plurality of applications are set to executed as a multi-application.

Like this, since the multi-application is executed in the smart phone 500, a user may simultaneously perform various works (website browsing, contents download, and multimedia message (S)MMS writing, etc.) with one or more applications in driving the remote snow removal system.

A message sent to the data communication unit 201 of the remote terminal device 200 installed at the site may use SMS data having a basic short sentence type.

To link data intimation between the applications, the smart phone 500 may transfer desired data information through a command line that transfers data when an application is executed.

In a scheme of linking data information between the same types of applications, the data information is linked between applications in the same types of platforms. When an application is driven, data of a small number of texts, for example, about 256 words, is easily processed. Accordingly, text data having a short sentence type is transmitted to the remote terminal device 200 with the application of the smart phone 500, and thus, information processing for inputting and outputting data is quickly executed at a high speed.

In a command line scheme, the native application 501 may transfer data information with an execution parameter at a time when another native application is executed. A scheme that links the data information through the command line may transfer only text data of up to a maximum of 256 words.

The scheme using the command line has a limit in a data information capacity, and, due to different platform (window mobile platform vs WIPI platform) structures of different types of applications (i.e., native application and WIPI application), it is unable to link the applications through the command line.

This can affect reception of large-scale information such as image information captured by the surveillance camera 204 connected to the remote terminal device 200. Such a limitation can be overcome by improving the specifications and performance of the applications and platforms of the smart phone 500, and it is stable to control driving of the pump 105 by transmitting a text type of SMS data of a short sentence.

According to the present invention, snow-removing work is previously decided through an operation of determining a road surface condition, and if the manger transmits information on the decided snow-removing work as SMS data by using the smart phone 500 in a scheme of transmitting a specific data code value, the SMS data is transmitted through the data communication unit 201 of the remote terminal device 200. The control unit 206 recognizes the SMS data to determine whether to drive the pump 105 according to a predetermined algorithm, stop driving of the pump 105, transfer a new signal to each function through the controller 209, or obtain information, and compares and outputs input values to perform control.

The remote snow removal system of the present invention may be remotely controlled in real time by the smart phone 500 depending on a road condition determined by the manager, and automatically driven in the order of condition setting and arbitrary time setting-driving state check-automatic data transmission-pump driving by the control unit 206 configuring the remote terminal device 200.

The related art apparatuses for spraying liquid on a road, which include a remote control function, are all installed to be neglected on roads, and thus, due to carelessness and negligence in surveillance, it is unable to respond to damage or robbery of expensive application components.

According to the present invention, detection, measurement, diagnosis, and warning are performed with the surveillance camera 204, the detection sensor 205, the flow rate measurement sensor 210, the warning sound unit 202a, the light lamp 202b, and the display unit 202c, and various pieces of information is received and obtained by the smart phone 500 able to process large-scale data, thus effectively preventing damage and robbery.

For example, contact impact information is detected by the detection sensor 205. When a physical impact is applied on the body 103 or the external case 107, the control unit 206 detects a state change and stores the detected information or sends the detected information to the smart phone (manager terminal) 500, and, by outputting warning sound through the warning sound unit 202a or flickering the light lamp 202b, the control unit 206 causes the state change to be visually output.

Likewise, since various pieces of site information, such as sound, intensity of illumination, speed, distance, etc., is obtained through the detection sensor 205, a condition of the snow removal system is clearly checked based on the obtained information, and a change in a flow rate of the spraying agent 102 is detected through the flow rate measurement sensor 210. Accordingly, it is possible to monitor and check whether supplement is necessary through various routes in consideration of a driven time.

Moreover, information of a road condition and a current facility management state am detected by the detection sensor 205, and various pieces of information necessary for driving the snow removal system is transferred to the manger in real time. For example, climatic and environmental information (such as a temperature and a humidity) affecting driving of the snow removal system, a contact impact applied on a structure, a residual amount of the spraying agent, and a loss state of the spraying agent are detected, and are transmitted as data to the manager.

The manager technically controls the snow removal system by collecting various pieces of information necessary for driving of the snow removal system, and the snow removal system is controlled by inputting simple SMS data to the smart phone 500 and transmitting the SMS data. Accordingly, system control is quickly, conveniently performed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

The present invention enables the continuous management of a snow removal system installed on a road to be remotely performed, and transfers various pieces of information, which is necessary for operating the snow removal system, such as a road condition and a current facility management state, to a manager in real time, thus enabling the remote control of the snow removal system to be efficiently, accurately performed.

What is claimed is:

1. A method of remotely controlling a snow removal system using an external case (107), in which a body (103) storing a spraying agent (102), a pump (105), and a nozzle (106) are installed, a remote terminal device (200) that is installed in the external case (107) and recognizes SMS data to be driven, and a smart phone (500) that includes an application (501) for transmitting and receiving a data value in connection with the remote terminal device (200), the method comprising:
accessing a mobile communication network (400) with the smart phone (500) to access the remote terminal device (200) through a data communication unit (201) in the snow removal system installed at a site in real time;
determining whether a user accessed through the accessing is an authorized manager, and, when it is determined that the accessed user is not the authorized manger, blocking the access to the smart phone to allow the access of the authorized manager using the smart phone;
transmitting data by using the smart phone (500);
driving a central processing unit (CPU) of the remote terminal device (200) with SMS data, transmitted through the transmitting, to output a data value;
driving the pump (105) installed at the site to spray the spraying agent (102) through the nozzle 106, or stopping operation of the pump (105) to stop the spray of the spraying agent (102);
determining whether to spray the spraying agent (102) according to whether the pump (105) is driven, and comparing data input or output values stored and set in the CPU and a memory of the remote terminal device (200) to transmit detection information to the manager;
checking a data value, transmitted through the transmitting, with contents displayed by the smart phone (500) to determine whether an error occurs, and determining whether to continuously perform a current operation according to the determined result;
obtaining collected information to check an overall state of the remote snow removal system to input and transfer necessary contents as SMS data by using the smart phone (500); and
feeding back all of the processed results to the smart phone (500).

2. The method of claim 1, wherein the processing of the SMS data processed by the remote terminal device (200) comprises:
transmitting the SMS data from the smart phone (500) to receive the SMS data;
extracting a teleservice ID from the SMS data;
checking an application corresponding to the teleservice ID;
determining whether the application matches the teleservice ID, and, when there is a mismatch therebetween, stopping a service, or, when there is a match therebetween, allowing generation of application data;
generating new application data;
mapping the generated application to an application program of the control unit (206) of the remote terminal device (200); and
driving, when SMS data based on the application is received, the remote terminal device (200) with the SMS data to control driving of the pump (105) to control the spray of the spraying agent (102).

3. The method of claim 1, wherein in the remote terminal device (200), the control unit (209) selectively controls one or more selected from among a display element unit (202), a surveillance camera (204), a detection sensor (205), and a flow rate measurement sensor (210), and transmits external environmental information with an application of the smart phone (500) in real time.

4. The method of claim 3, wherein a control command executed by the controller (209) is executed through the CPU that receives the SMS data of the smart phone and has an integrated control function for a microprocessor or a microcomputer comprised in the control unit (206) of the remote terminal device (200), a programmable logic controller (PLC) that controls the pump (105) according to a programmed command input as data of the smart phone (500) side, and a remote terminal unit (RTU) that collects data output from the pump (105) and performs comparison control.

5. The method of claim 3, wherein the remote terminal device (200) transmits signals, transmitted between a programmable logic controller (PLC) and a remote terminal unit (RTU) of the control unit (206), to the smart phone (500) through a human machine interface (HMI) to display an image or text corresponding to the signals.

6. The method of claim 4, wherein the remote terminal device (200) transmits signals, transmitted between the PLC and RTU of the control unit (206), to the smart phone (500) through a human machine interface (HMI) to display an image or text corresponding to the signals.

7. The method of claim 3, wherein the external environmental information transmits control and measurement information which comprises one or more of a contact impact on a structure of the snow removal system installed on a road, sound, light, an acceleration, a distance, a humidity, a temperature, and a flow rate of the spraying agent.

8. The method of claim 3, further comprising outputting a flow rate detected by the flow rate measurement sensor (210) to the control unit (206), and comparing and calculating the output value to check whether the spraying agent (102) is lost and robbed and an operation is normally performed based on a change amount of the flow rate by using the smart phone (500).

9. The method of claim 1, wherein,
the smart phone (500) comprises:
an application (501) transmitting SMS data to the control unit (206) through the data communication unit (201) of the remote terminal device (200);
a program operating system (OS) (502) comprising the application (501), and driving the remote terminal device (200);
a telephoney application interface (TAPI) (503) receiving data transmitted from the remote terminal device (200) by using an inter-process connection (IPC), extracting a teleservice identifier (ID) from the data, checking the application (501) corresponding to the data with the teleservice ID, generating data of the application (501) in a type enabling a service by the checked application (501) with user data included in the SMS data and the teleservice ID, and mapping the generated data to the checked application (501); and
a memory (504) storing and extracting transmitting and receiving data,
wherein the smart phone (500) control the remote terminal device (200).
